(19) United States
(12) Patent Application Publication
(10) Pub. No.: US 2003/0214081 A1
(43) Pub. Date: Nov. 20, 2003

(54) Method and apparatus for molding structural composites

(75) Inventor: James Michael Ockers, Dearborn, MI (US)

Correspondence Address: BRINKS HOFER GILSON & LIONE, P.O. BOX 10395, CHICAGO, IL, 60611, US

(73) Assignee: Visteon Global Technologies, Inc.

(21) Appl. No.: 10/146,298

(22) Filed: May 15, 2002

(51) Int. Cl. B29C 70/00

(52) U.S. Cl. 264/510; 264/571; 425/388

(57) ABSTRACT

A method and apparatus for molding structural composite materials. The method applies positive pressure on a mold vent after filling the mold with resin to reduce the size of the voids by collapsing the voids.

### BACKGROUND OF THE INVENTION

1. Field of the Invention

The present invention relates to an article and a method provide improved chassis components in a motor vehicle, and in particular, a high fiber loaded composite component to be used in transverse springs for chassis components.

2. Description of the Prior Art

Transversely extended leaf springs are a common component in vehicles today as part of the suspension system. These springs provide vehicle height and attitude adjustment during road condition changes to maintain a suitable ride and level attitude during movement of the vehicle. Leaf springs are generally of a steel or other alloy composition and are a heavy component in the vehicle. It is an object of engineers throughout the world to reduce vehicle weight, wherever possible, to improve gas mileage. One such possibility is to replace metal components with lighter plastics and composites.

Composite components have been gaining acceptance in the aerospace, military and automotive fields because of their high strength to weight ratio. The light weight is a desirable aspect, but mechanical strength has been a major issue. With composites, the mechanical performance of the composite components is directly related to the amount of reinforcement (fiber loading) provided in the composite component.

Composite components are generally manufactured using resin transfer molding (“RTM”). RTM is a common processes that was originally introduced in the 1940s. In this process, a two-part, matched mold (or tool) is made, a preform or reinforcement is placed into the mold, and the mold is closed. A resin is then pumped at low pressure through injection ports into the mold and the resin follows a predesigned path through the preform. Both the resin and mold are generally preheated to decrease the viscosity of the resin as needed for the application.

Many patents have been issued addressing methods to produce stronger composite components. Two important factors that affect the mechanical strength of a composite component are the percentage of fibers and the number and size of voids (or air pockets) in the finished composite component.

U.S. Pat. No. 5,686,038 issued to Christensen uses porous tool and articulating inserts in the mold. The porous inserts can absorb some of the air as the articulating inserts compress the part. While functional, this make for expensive and inflexible tool design.

In U.S. Pat. No. 5,449,285 issued to Choiniere, lances are forced into the mold cavity by linear actuators to pierce the component and allow gas to escape from the component. This is also a mechanical complication to the tool.

U.S. Pat. No. 5,443,778 issued to Schlingman uses a vent design with a flow regulator so the excess resin may not escape into the vent well. This design relies on the pressure from the injection flow to push the air pockets out of the molded part. However, because of the low viscosity of composite resins, many air pockets will still be left in the component.

The above-mentioned drawbacks of U.S. Pat. No. 5,449,285 are improved in U.S. Pat. No. 5,322,109 issued to Cornie. Cornie utilizes a pressure through the vent tube. However, two separate chambers (one for vacuum and a second for pressure) are required. The mold must be transferred in the middle of the process between the chambers. This is exceptionally onerous.

U.S. Pat. No. 5,023,041 issued to Jones uses an improved process over the previous mentioned. This invention, however, does not have a vacuum inlet. Additionally, the excess resin will flow through valves that will need to be replaced after each part is formed. This is impractical for mass production applications such as automotive components.

The use of a composite components for a leaf spring has been investigated in previous patents. In U.S. Pat. No. 4,659,071, issued to Woltron, the use of a composite structure for a plastic leaf spring is described. In this patent, a continuous web of reinforcing layers is used. The fibers are impregnated with a hard plastic and the web is wound in a continuous roll and placed in the mold. While potentially functional, this is a highly complicated and expensive method.

Another method for manufacturing a plastic leaf spring is shown in U.S. Pat. No. 4,747,898, also issued to Woltron. This method uses previously cured plastic strips reinforced with high strength fibers aligned in the direction of the spring. This is also a difficult and expensive method of manufacture for a plastic leaf spring.

From the above it is seen that there remains a need for a method of manufacturing a composite structural component with further enhanced strength, reduced weight and decreased cost.

### SUMMARY OF THE INVENTION

In accordance with the present invention, a method is provided for manufacturing composite structures with sufficient strength to be used in a vehicle as a structural chassis component.

Resin molding is generally a slow process due because the chemical reaction of the reactive fluid injected into the tool must be tailored such that the onset of gelatin occurs after the preform or reinforcement, which may be a fiber mat, is saturated with the resin. The flow rate of the resin through the reinforcement is a function of the resin's viscosity, the reinforcement's permeability and the driving pressure. To aid in resin flow, the mold is generally preheated. With regard to driving pressure, there is an upper limit to this pressure in order to avoid displacement of the reinforcement as caused by the flow of the resin (commonly referred to as “fiber wash”). Increased fiber loading, the parameter that is maximized for enhancing strength of the structural composite, has an exponentially decreasing effect on permeability of the reinforcement.

To decrease air pockets or voids in the final part, and therefore increase its strength, a good seal must be formed between the mold halves. This seal also allows a vacuum to be drawn within the mold cavity, prior to injection of the resin, aiding in cycle time and assisting in decreasing void production. After the injection process is complete and while the resin is still in a liquid state, the vacuum can draw air into the mold and potentially into the composite part, increasing the size of any existing voids and decreasing the mechanical strength of the finished component.

The present invention uses positive pressure on the resin while the resin is still in the liquid state after the mold cavity is filled. The purpose of this step is to remove pressure gradient in the mold cavity and collapse any voids. The mold material and inserts accordingly must be of sufficient stiffness to withstand this positive pressure.

During mold filling, the mold is vented in a manner to direct resin flow to a vent well located either in the highest point in the mold cavity or above the mold cavity. Some resin during the fill process will partially fill the vent well. When the positive pressure is applied, this resin from the vent well will be forced back into the mold cavity collapsing any voids. The flow rate will be quite low at this point, resulting in the added benefit of improved microscale wet out and the ability to achieve higher fiber loadings.

Using this technique will permit higher fiber loadings for random reinforcements. It is anticipated that fiber loading of greater than 50% by volume can readily be achieved It is generally accepted that with current liquid molding, the maximum fiber loading by volume is 30-35% by volume for random reinforcements. The benefit of increasing the fiber content in a composite component is improved mechanical properties, such as the modulus and strength, which enable lighter weight structural components to exhibit strengths approaching that of metals. This will further allow a lower cost (where fiber costs are lower than resin costs) and lower weight part to be used for structural components, particularly traverse springs for automotive applications.

While the discussion has been directed towards RTM, practitioners skilled in the art will find equal applicability of the present invention to other liquid molding processes, such as structural reaction injection molding (SRIM) and injection compression molding (ICM).

Additional benefits and advantages of the present invention will become apparent to those skilled in the art to which the present invention relates from the subsequent description of the preferred embodiments and the appended claims, taken in conjunction with the accompanying drawings.

### BRIEF DESCRIPTION OF THE DRAWINGS

FIG. 1 is a perspective view of an embodiment of the present invention;

FIG. 2 is a flow chart illustrating the preferred steps in carrying out the method of the present invention; and

FIG. 3 is a front view of the vent well of the present invention.

### DETAILED DESCRIPTION OF THE PREFERRED EMBODIMENT

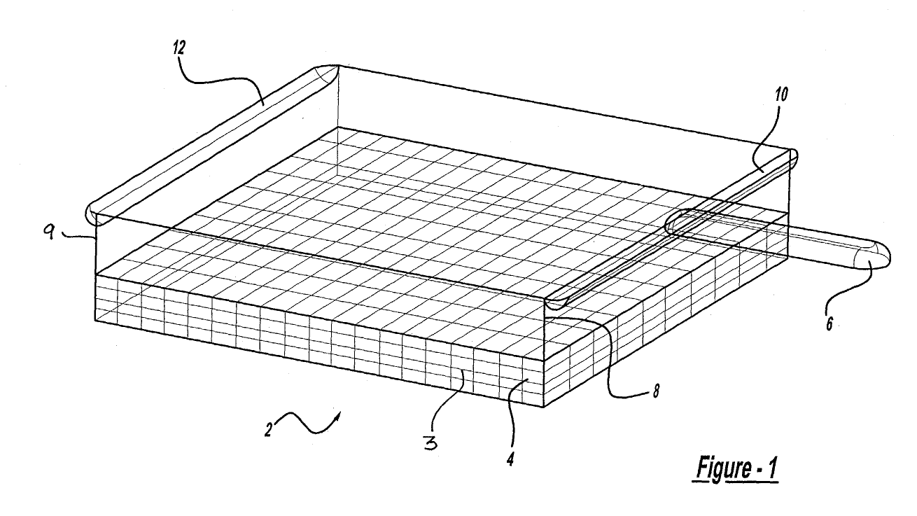

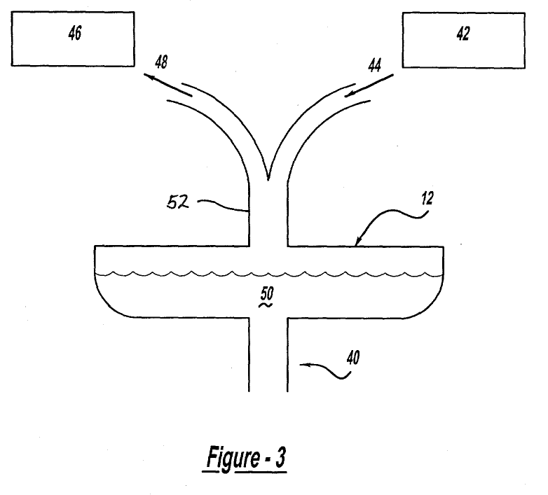

Referring now to the drawings, as seen in FIG. 1, a mold 2 is shown for forming a composite part, namely a square plaque 4. In this case, uncured resin 50 (shown in FIG. 3) is introduced to a mold cavity, where a preform or reinforcement 3, shown as a mesh grid, has been located. The resin 50 enters through resin inlet 6 and travels to the mold 2, via an inlet runner 10 and an edge gate 8, both of which extend the width of the mold 2. On a side of the mold 2, generally opposite the resin inlet 6, is a vent well 12. Vented uncured resin 50 is collected in vent well 12, which is located at the top of a vented shear edge 9 and above cavity for forming the square plaque 4 itself. Both vacuum and post injection pressure are applied at a port 52, as shown in FIG. 3, communicating with the vent well 12.

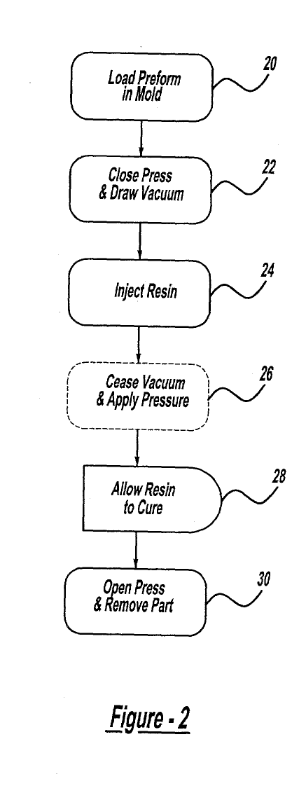

Referring now to FIG. 1 and FIG. 2, according to the method of the present invention, the first general step, designated as block 20, is to load a preform 3 into the mold 2. The manner of this loading is well within the skill of the ordinary practitioner and need not be described in detail herein. Next, in block 22, the press is closed and a vacuum is drawn through vent well 12. With the vacuum drawn, uncured resin 50 is injected through resin inlet 6 at block 24. The uncured resin 50 flows through the inlet 6, through gate runner 10 and through edge gate 8, into the mold cavity and about the preform 3. Excess uncured resin 50 travels up through the vented shear edge 9 and pools in the vent well 12. After the mold 2 is filled, the vacuum is ceased through the vent well 12 and positive pressure is applied through the vent well 12. This is shown at block 26. It is during this step that the positive pressure is used to collapse voids in the component being molded. In resin cure step of block 28, the uncured resin 50 is allowed to cure with pressure still being applied. Once cured, the press is opened and the completed part, square plaque 4, is removed at block 30. The process is now complete.

Referring now to FIG. 3, the vent well 12 is shown in isolated detail. As a vacuum source 46 draws the vacuum (the step of block 22) on the sealed mold 2 by pulling air in vacuum direction 48 through port 52, the uncured resin 50 enters vent well 12 through a vent inlet 40. The vent inlet 40 may be a vented shear edge 9 as mentioned above. When the mold 2 is filled with uncured resin 50 to the desired volume, the vacuum source 46 is turned off and a positive pressure source 42 is turned on. Gas pressure from the positive pressure source 42 is applied in pressure direction 44 and through port 52, forcing the uncured resin 50 out of the vent well 12 and back through the vent inlet 40 and into the mold cavity. Any voids in the resin of the uncured component, collapsed due to the applied back pressure, the returning uncured resin and the inability of resin 50 within the mold cavity to exit through the seals of the mold 2 or the gate runner 10. This pressure, from the pressure source 42 is maintained until the resin 50 is cured. Once cured, the pressure source 42 is turned off, the mold is opened and the structural composite is removed.

While the above description constitutes the preferred embodiments of the present invention, it will be appreciated that the invention is susceptible to modification, variation and change without departing from the proper scope and fair meaning of the accompanying claims.

I claim:

1. A method for molding a composite component, the method comprising the steps of:
loading a preform into a mold;
closing the mold;
drawing a vacuum in the mold through a vent well;
injecting a resin material through a resin inlet in the mold;
causing a portion of the resin to at least partially fill the vent well;
stopping drawing of vacuum after the mold is injected with the resin;
applying a positive pressure through the vent well and forcing at least some of the resin from the vent well back toward the mold;
curing the resin; and
opening the mold and removing a completed component from the mold.

2. The method of claim 1 wherein said injecting step injects the resin through the resin inlet to an edge gate and into the mold.

3. The method of claim 2 wherein said injecting step injects the resin from the resin inlet to a gate runner and subsequently to the edge gate.

4. The method of claim 1 wherein said steps of drawing a vacuum and applying a positive pressure are done through a common port.

5. The method of claim 1 wherein the step of causing at least a portion of the resin to at least partially fill the vent well further causes the resin to flow through an edge vent to the vent wall.

6. The method of claim 1 wherein the method is a resin transfer molding method.

7. The method of claim 1 wherein the method is a vacuum assisted resin transfer molding method.

8. The method of claim 1 wherein the method is a structural reaction injection molding method.

9. The method of claim 1 wherein the method is a injection compression molding method.

10. An apparatus for molding structural composite components comprising:
a pair of mold halves matingly defining a mold cavity;
an inlet edge gate defined along one end of said mold cavity;
an inlet in fluid communication with said edge gate;
a vent gate defined along an edge of said mold generally opposite of said edge gate;
a vent well in fluid communication with said vent gate;
a vacuum source coupled to said vent well; and
a positive pressure source coupled to said vent well.

11. The apparatus of claim 10 wherein said vent well is located above said mold cavity.

12. The apparatus of claim 10 wherein said vacuum source and said positive pressure source are in fluid communication with said vent well through a common port.

13. The apparatus of claim 10 wherein said edge gate extends substantially the width of said mold cavity.

14. The apparatus of claim 10 wherein said edge vent extends substantially the width of said mold cavity.
